(19) United States
(12) Patent Application Publication
(10) Pub. No.: US 2003/0225876 A1
(43) Pub. Date: Dec. 4, 2003

(54) Method and apparatus for graphically depicting network performance and connectivity

(76) Inventors: Peter Oliver, Cameron Park, CA (US); David Hudock, Rocklin, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/158,228

(22) Filed: May 31, 2002

(51) Int. Cl. G06F 15/173; G09G 5/00

(52) U.S. Cl. 709/224; 345/734

(57) ABSTRACT

A network management software system monitors and displays performance and capacity information about networks and computers using computer graphics similar to weather maps one might see on television. High-resolution color graphics allow the display of thousands of pieces of performance on network information on one computer screen. This allows end users to view computer performance metrics such as processor utilization, disc capacity and application availability, in large network computing environments across thousand of network elements at a glance. Virtually any metric that can be determined from a network element may be displayed. Thus, performance information is collected and displayed to the end user in a color-coded graphical format that also depicts the network as opposed to the traditional tabular format. This eliminates the need for the end-user to “work” the application in an attempt to monitor performance.

### FIELD OF THE INVENTION

The present invention relates generally to monitoring and depicting the performance of network elements and, more specifically, to monitoring network elements, publishing performance metrics for the network elements in message streams and graphically depicting multi-colored performance views of the network based on the performance metric data.

### BACKGROUND OF THE INVENTION

In recent years, the size and complexity of computer networks has increased dramatically. The increase has brought with it increased demand for network resources, by users and automated processes, for all types of networks including voice, data, IP, ATM, optical and other types of networks. Because of the large demand for and value of network resources, much attention is devoted to maintaining acceptable levels of network performance. However, because network performance can degrade to unacceptable levels relatively quickly, maintaining network performance tends to require continuous monitoring of hundreds to thousands of network elements, each with multiple points of failure and performance degradation, simultaneously.

Conventionally, networks have been monitored for fault conditions in individual devices. When a network element fails, an alarm has been used to notify a network administrator of a single or multiple point failures. While alarms are useful for detecting failures, they are not generally useful for detecting performance bottlenecks or for monitoring the overall health and state of a network.

To monitor network performance, conventionally performance data has been stored into a table that textually identifies a network element, a performance characteristic and the level of performance corresponding to the network element and the performance characteristic. This tabular format limits how much data can be displayed to the end user in one screen. Thus the user is forced to work the computer and “page” through volumes of data in an effort to extract useful information. This method of viewing performance data is overwhelming in a large network environment. Moreover, conventional systems do not collect performance metrics in an efficient manner from diverse network elements.

Accordingly, there is a need for a system and method to monitor certain performance metrics of hundreds to thousands of diverse network elements and to display the performance metrics in a single, useful network performance depiction. There is a further need to assign colors to various performance levels corresponding to the performance metrics and to use the assigned colors as part of a network map to depict network performance. There is a further need to graphically monitor network performance in different views and to allow the user the ability to “drill down” on certain parts or elements within the network to obtain further or more specific network performance information. There is still a further need for a scalable method of continuously and unobtrusively monitoring network elements that continuously publishes performance metrics for real-time monitoring.

### SUMMARY OF THE INVENTION

According to the present invention, a network management software system monitors and displays performance and capacity information about networks and computers using computer graphics similar to weather maps one might see on television. High-resolution color graphics allow the display of thousands of pieces of performance on network information on one computer screen. This allows end users to view computer performance metrics such as processor utilization, disc capacity and application availability, in large network computing environments across thousand of network elements at a glance. Virtually any metric that can be determined from a network element may be displayed. Thus, performance information is collected and displayed to the end user in a color-coded graphical format that also depicts the network as opposed to the traditional tabular format. This eliminates the need for the end-user to “work” the application in an attempt to monitor performance.

According to an embodiment of the present invention, one or more polling agents is coupled to a network. The polling agent is configured to monitor certain elements of the network at a predetermined frequency. Based on the results of the monitoring, the polling agent periodically publishes performance metrics over a network message queue.

An archive and a performance monitor are configured to exchange data with the network message queue and receive the published performance metrics. The archive stores the performance metrics and may archive the performance metrics for the monitored elements in a multi-dimensional format for on-line analytical processing (OLAP). The performance monitor stores color data that correlates one or more performance levels for a performance metric to corresponding colors for that performance level. For example, red may indicate that high-performance and blue may indicate low performance.

The performance monitor receives the published performance metrics and, based on a network map and assigned colors, graphically displays elements in the network. Each displayed network element is displayed in whole or in part using the assigned colors to indicate the level of performance of a metric associated with that network element. In this manner, a large number of network elements may be simultaneously displayed, in its physical or logical configuration relative to other network elements, together with color to indicate performance information. This visualization technique provides the ability to see the forest from the trees by efficiently aggregating a large amount of performance data as well as logical and physical relationships into a single display. It is superior to conventional techniques, which generally provide textual data in tables to summarize the performance of hundreds or thousands of network elements. Conventional performance monitoring techniques do not provide a practical mechanism for allowing one to monitor the performance of a network.

### BRIEF DESCRIPTION OF THE FIGURES

The above described features and advantages of the present invention will be more fully appreciated with reference to the accompanying figures and detailed description.

FIG. 1 depicts a method of graphically depicting performance metrics of network elements according to an embodiment of the present invention.

FIG. 2 depicts a functional block diagram highlighting network systems for graphically depicting performance metrics of network elements according to an embodiment of the present invention.

FIG. 3 depicts a view of a master database according to an embodiment of the present invention.

FIGS. 4A and 4B depict network metric configuration information stored in the database according to an embodiment of the present invention.

FIG. 5 depicts a method of operation of the controller according to an embodiment of the present invention.

FIG. 6 depicts a method of configuring the polling agent in a real time manner according to an embodiment of the present invention.

FIG. 7 depicts a method of monitoring a network at polling agents according to an embodiment of the present invention.

FIG. 8 depicts a method of monitoring and displaying performance according to the present invention.

FIG. 9 depicts an illustrative example showing a screen for displaying performance metrics for a network view according to an embodiment of the present invention.

### DETAILED DESCRIPTION

According to an embodiment of the present invention, thousands of network elements and systems may be represented graphically in one (1) screen full of information. This allows the end-user to monitor very large networks and quickly spot potential problems before service is affected. Additionally, many distributed proxy-polling agents may be used to allow large numbers of users to view performance data simultaneously without adversely affecting the network from disruptive polling. The following figures describe embodiments of the methods and systems utilized to monitor and visualize the performance metrics associated with a network according to the present invention.

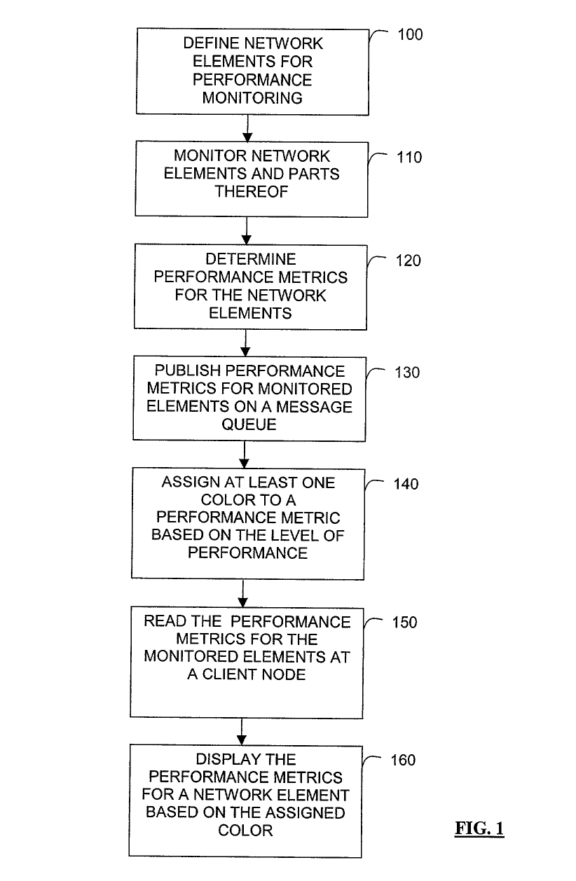

FIG. 1 depicts a method of graphically depicting performance metrics of network elements according to an embodiment of the present invention. Referring to FIG. 1, in step 100 a network is defined for performance monitoring. The network may be defined in a conventional manner through a “discovery” process pursuant to which an automated polling program is used to discover the type and configuration of network elements in a network and the connections between network elements in a network. Once the network configuration is discovered, it may be stored as a network map. The network map may be stored in any convenient format. In general, the format of the network map includes a syntax that allows one to identify network elements, their type and configuration and interconnections. Any convenient syntax may be used. The network map, once known, may be displayed in a conventional manner by a rendering program. The network map, when displayed, allows one to see logical or physical interconnections between network elements that comprise a network.

After the network elements for performance monitoring are defined in the network map, in step 110, the network map is used to identify the network elements that are to be monitored. The network elements may be monitored by, for example, polling them in five minute intervals. It will be understood, however, that any convenient interval may be used. The polling operation may be configured to retrieve from the monitored network elements performance metrics. The performance metrics may be any convenient performance measurements. For network nodes, the following performance metrics may be used, for example: availability, CPU busy, packet loss, latency, Link Availability Average, Link Availability Maximum, Link Availability Minimum, Link Errors Average, Link Errors Maximum, Link Errors Minimum, Link Utilization Average, Link Utilization Maximum and Link Utilization Minimum. For links, the following performance metrics may be used, for example: Availability, Utilization, Errors, Discards, Total Packets, Packets Per Second, Total Errors and Errors Per Second. For monitoring network services, protocols may be defined to determine metrics for, for example, latency and availability for http: Servers, SMPT, POP3, NNTP, NTP, DNS or DHCP Servers. The foregoing performance metrics are illustrative only. It will be understood that any performance metric may be defined for use.

In step 120, the performance metrics are determined through passive collection, such as receiving SNMP messages from monitored elements or agents, polling or other monitoring techniques. Polling may be performed to read the performance metrics directly from a server that monitors the network elements of interest. Alternatively, polling may result in the collection of data for the network elements from which the performance metric is derived through a predetermined calculation.

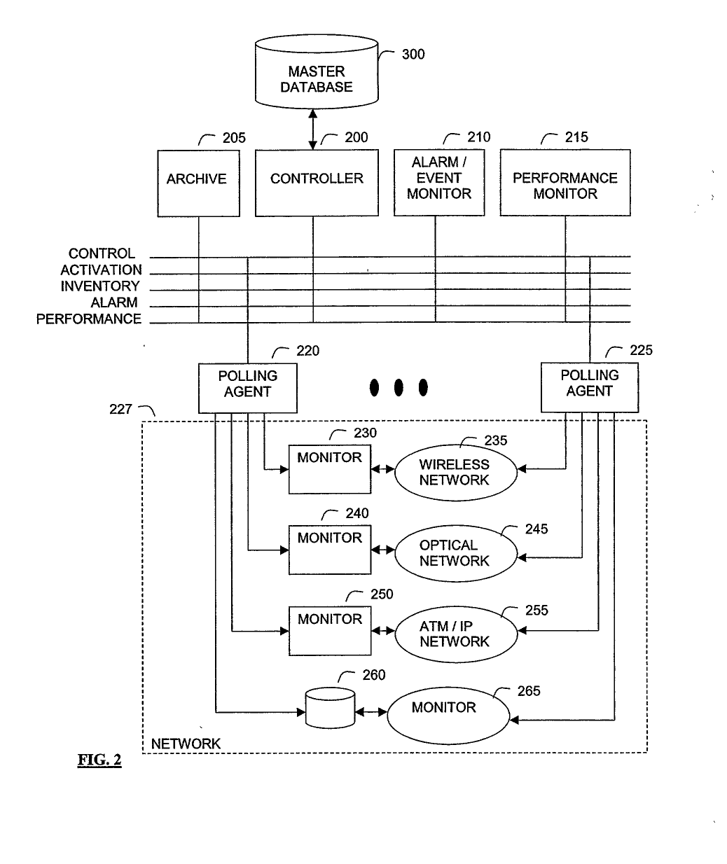

In step 130, the performance metrics for monitored elements are published on a message queue. The message queue may be in an extensible markup language format (XML) having a known format and structure that permits the extraction of network element identifiers, associated performance metrics and authorization information. The authorization information may be used to prevent unauthorized access to data in the message queue. Steps 110 and 130 previously described may be performed through a polling agent 220 as shown and described with reference to FIG. 2.

The message queue, once published, may be read by network elements in order to obtain the performance metrics collected for each network element. The network elements may include an archival unit and a performance monitor. The archival unit may be configured to store the performance data for subsequent retrieval and use in the performance monitor. Additionally, the archival unit may store the information in any convenient database format. However, according to one embodiment of the invention, the archival unit stores the performance metric information for the monitored network elements in a multi-dimensional representation for later retrieval pursuant to on-line analytical processing (OLAP) techniques. Moreover, the archival unit may include within it OLAP definitions and templates for configuring performance reports according to pre-determined criteria.

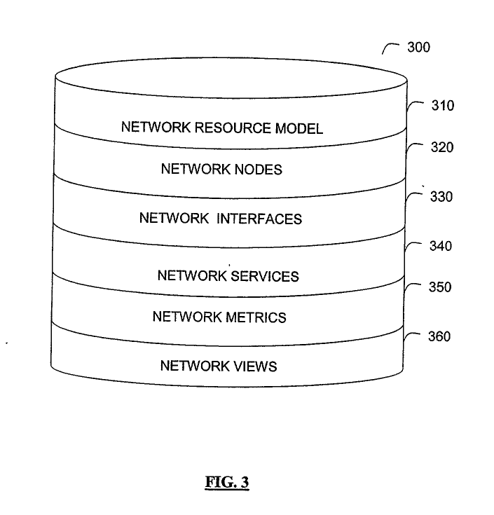

In step 140, the performance monitor is used to assign at least one color to a performance metric based on the level of performance. The color data may be assigned, for example, so that a different color is assigned to each performance level between 0% and 100% in increments of 10. Alternatively, a continuous palette of colors may be assigned to blanket the range of 0% to 100%. Still other color combinations are possible in order to visually convey performance information to the user. FIG. 3A illustrates a database record used by the performance monitor to store color information in connection with a performance metric. This information may be stored and made available for the user to update through a simple menuing program that includes each performance metric and allows the user to assign colors to performance levels for storage as a data record.

In step 150, the performance metrics for the monitored elements are read at a client node running the performance monitor. The performance metrics may be read directly from polling agents as the performance data is published. Alternatively, the archival unit may publish the performance metrics in a message queue which is read by the performance monitor. In the latter scenario, the archival unit may output an on-line analytical processing (OLAP) report or reports over the message queue for rendering by the performance monitor.

In step 160, the performance monitor displays the network. Network elements within the network may be depicted as smart icons with interconnections to other smart icons. The smart icons may be partially or entirely colored according to a performance metric of interest. For example, the network may be rendered based on the network map. Then, the user may select a performance metric for display. The performance monitor will then color the smart icon for each network element with the appropriate color based on the level of performance for the selected performance metric for that network element. Thus, the user will be shown a graphic depiction of the network with color highlighting the performance of the overall network. The performance monitor will update with color associated with the smart icons representing the network elements in real time as the performance metrics are updated periodically over the published message bus.

In addition, the user may show the same network map using different performance metrics to color the smart icons representing the network elements one at a time. Alternatively, the user may “drill” down on parts of the network to see more specific information. When the network map is hierarchical, the performance map may display subsections of the network that are selected. Each subsection has its own “view” which provides more detail about that part of the network. When this is done, the smart icons in the lower level view will also be colored according to the color scheme of the selected performance metric.

FIG. 2 depicts a functional block diagram highlighting network systems for graphically depicting performance metrics of network elements according to an embodiment of the present invention. Referring to FIG. 2, the network may include a controller 200, a master database 300, an archive 205, an alarm/event monitor 210, a performance monitor 215 and one or more polling agents 220. The polling agents 220 are configured to monitor network elements over one or more networks directly or via performance monitors.

The monitoring system 205 may be deployed as a program running on a single computer system. Alternatively, the monitoring system may be deployed as a program running on one or more distributed servers coupled together over a network. The number of polling agents 220 that are deployed may depend on the number of network elements being monitored and the performance of the network. For example, Gigabit Ethernet networks may call for more polling agents per network element than lower frequency networks such as 10 and 100 Megabit per second networks. In general, the number of polling agents is determined to permit each polling agent to complete a polling or monitoring cycle in less time than that required by a polling or monitoring cycle of the network elements or monitors being polled.

The elements of the monitoring system 225 are configured to exchange messages over message queues that control and coordinate the configuration and operation of the network system. The queues may include, for example the control queue, the activation queue, the inventory queue, the alarm queue and the performance queue. Each of the elements may “listen” to one or more message queues by retrieving messages from the queues or may publish messages over one or more message queues for other elements of the system.

The controller 200 is coupled to the master database 300. The master database 300 is a relational database that stores configuration information used to describe the network and all of the elements within it that are to be monitored. An illustrative view of the master database 300 is shown in FIG. 3. Referring to FIG. 3, the master database includes configuration tables 310 to 360 that describe the network and configure the system. The configuration tables include the network table 310, the network nodes table 320, network interfaces table 330, the network services table 340, the network metrics table 350 and the network views table 360. The tables may be considered individual databases or portions of a database and may be consolidated into a single master database or distributed among one or more control databases.

The network model 310 stores a network resources model that describes each of the elements of the network 227 that is being monitored and parts thereof. The network table may store information pertaining to more than one network. The network model may be based on any convenient schema and generally includes a syntax that permits a hierarchical description of each network element, including switches, routers, hubs, servers, databases and other network elements. The network model further includes data that describes interconnections or interfaces between network elements. In general, the network model may use classes to and attributes to describe network elements. The network model may further use super classes to describe complex objects and subclasses to describe variations within a class using any convenient schema. The network model may also use containment information to associate one object with another when it is part of that object.

The network table 310 may reference the network nodes table 320 which, according to one embodiment of the invention, sets forth the network elements within the network described in the network according to the schema. The network nodes table 320 may further include data for each network element that describes which polling agent 220 is assigned the task of monitoring that network element as well as network address information sufficient to identify the network element. Additionally, the network elements table may include a list of performance metrics that is to be retrieved from each network element. The network elements table may also reference the network interfaces table 330 and the network services table 340 in a hierarchical manner to describe each node.

The network interfaces table 330 may include data for each interface within a network element. For example, ports of a router may each be an interface described in the network interface table 330. For each interface or interface type, the interface includes identification information that is sufficient for the polling agent to identify the interface and further includes metrics that are to be monitored for that interface together with any protocol or schema information necessary to obtain the performance metrics. The protocols and or schemas may include SNMP, TL1, telnet, ASCII or any other convenient protocol or schema.

The network services table 340 may include data for services that relate to network elements. For example, the network services may include http: based web services, and IP based network services such as Mail and DNS. The network services table may include for each network node an identification of a type of service that is to be tested along with any protocol information or service address information that may be used to perform the testing. For http and IP services testing, tests may be defined and referenced to measure, for example, availability and latency. Services test protocols may be stored as part of the network services table 340.

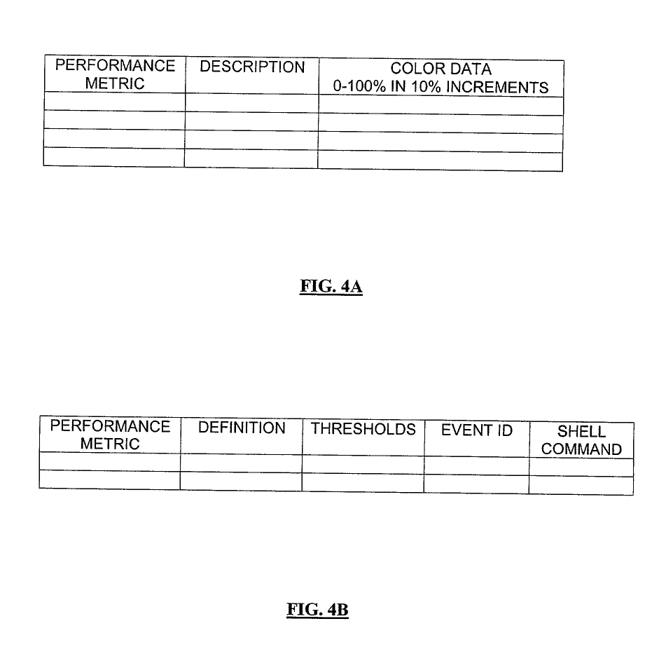

The network metrics table 350 may illustratively included information shown in FIGS. 4A and 4B. The network metrics table 350 may include, for example, that information which defines each metric and associates color data with different levels of performance. As shown in FIG. 4A, each performance metric may have its own color scheme. Alternatively, one color scheme may be chosen for all of the performance metrics. In general, a particular color may be assigned to each performance level of multiple performance levels for any particular metric. Performance levels may be set at any convenient increments, including 0-100% at 10% increments.

As shown in FIG. 4B, the network metric table may further specify thresholds, event identifiers and shell commands associated with a performance metric. For example, the thresholds may indicate critical, major and minor thresholds. The event ID and/or shell command may be used to invoke shell one or more shell scripts that initiate certain actions in response to the thresholds being met. The scripts may cause messages to be displayed to a user pertaining to the performance metric. The messages may be in the form of textual warnings, sounds, or other displays including displays which highlight the network element having the performance metric which triggered the event.

The network views table 360 may include graphical information pertaining to different network views defined by a user. The network views may include, for example, smart icons that depict each network element, interconnections between the elements, and graphic information which a user has defined in order to conveniently depict a network. There are generally multiple views that are used to depict large networks, each view being hierarchical. The network views may include other graphics that help geographically and spatially orient the network elements that facilitate understanding the network topology of the network being monitored.

For example, a network may be comprised of many subnets that are implemented at diverse facilities across the United States. With such a network, the network views might include a top level view of the network that includes a graphic depicting the United States with active icons located on the map at locations representative of each subnet. Additional views may be defined for each subnet which explode the subnet and organize the elements and any subnets within the subnet in a logical manner for the user. These views, once defined by the user, are intuitive and help the user grasp the network topology in a way that facilitates management of the network.

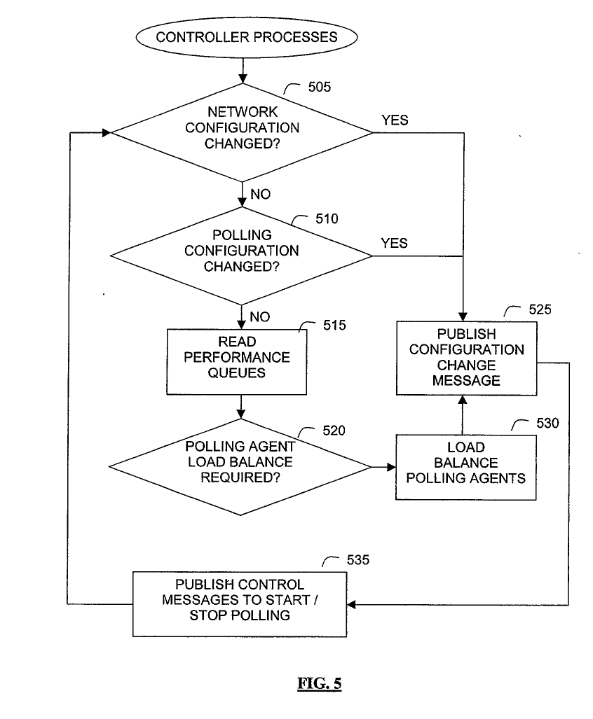

The controller 200 interacts with the database 300 and all of the elements of the performance monitoring system over the message queues. FIG. 5 depicts an illustrative view of processes of the controller which are used to control performance monitoring according to an embodiment of the present invention. In general, the controller is used to interact with the database to make changes to the database that reflect, for example, changes in the network configuration. The controller may include various user processes that allow these changes. Once changes are made, the controller issues control messages indicating changes have been made over the control queue. Elements of the performance monitoring system then respond to these control messages to retrieve the most up to date information about the network. For example, referring to FIG. 5, in step 505 the controller 200 determines whether the configuration of the network has changed. If not, then step 510 begins. If so, then in step 525 the controller publishes a configuration changes message over the control queue. The other elements of the system, including the polling agents listen to the control bus, in response, retrieve updated configuration information by reading the database 300 and storing the updated information into memory.

In step 510, the controller determines whether the polling configuration has changed. These changes may include changes to the polling frequency, changes in the metrics which are being monitored or other changes. If not, step 515 begins. If so, then step 525 begins and the controller publishes a configuration changes message over the control queue. The other elements of the system, including the polling agents listen to the control bus and retrieve the updated information.

In step 515, the controller may read the performance queues to retrieve messages published by one or more polling agents 220. The polling agents may publish cycle information that sets forth data on how long it took for the polling cycle to complete. The cycle information may be, for example, start time and stop time messages. Alternatively, the cycle information may include elapsed time information, historical cycle time information and statistics or any other convenient information relating to cycle time.

In step 520, when more than one polling agent is present, the controller determines whether load balancing among polling agents is required. If so, step 530 begins. If not, step 540 begins. Load balancing may be required if there is a significant difference between the polling cycle times among the polling agents as determined by any convenient algorithm. One algorithm may be determining a difference between the high and low performers, dividing the difference by the cycle time and performing the load balancing if the difference, as a percentage, exceeds a predetermined threshold. Other criteria may be used for load balancing including taking the difference between the cycle time and the maximum permissible cycle time and performing load balancing when a predetermined threshold is exceeded.

In step 540, the controller performs load balancing to balance the cycle times required for polling among the polling agents. The load balancing in general may be performed by reassigning network elements, interfaces or services monitoring from a heavily loaded polling agent to a more lightly loaded polling agent. This reassignment is made by updating the configuration tables within the database 300 with to associate a lightly loaded polling agent with additional network element, interfaces or services and to remove associations between heavily loaded polling agents and network elements, interfaces or services. The number of reassignments may be made based on any convenient criteria. The number may be proportional, for example, to the amount of difference in cycle time between the fastest and slowest polling agents.

In step 525, the controller publishes messages including that the configuration has changed over the control bus. The controller may also publish messages from time to time over the inventory and activation buses when new network equipment is installed. These messages may be used by processes within the controller 200 or one of many controllers 200 in distributed controller implementations to discover the new network element and its attributes and store the new element in the database 300. These messages may also be used to make configuration changes to the network which are acted upon and reflected in network configuration changes in the database 300 after the change occurs. In step 540, the controller may publish from time to time control messages to start and stop polling or to conduct polling for one or more specific metrics to obtain near real time information. The latter scenario is known as demand polling.

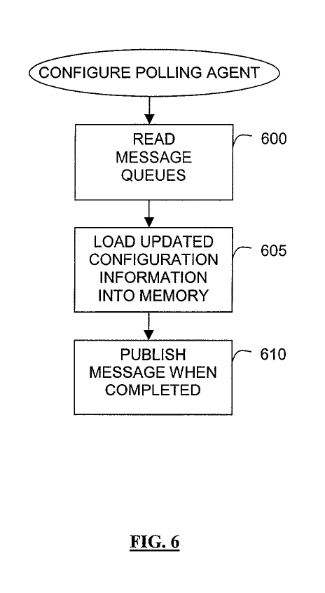

The polling agents 220 are configured to retrieve messages from the message queues. The polling agents include memory for storing the most up to date version of the network elements, interfaces and services that the polling agent is responsible for controlling. FIG. 6 depicts a method of configuring a polling agent for performance monitoring according to an embodiment of the present invention. Referring to FIG. 6, in step 600, the polling agent listens to the control message queues. In step 610, when the polling agent receives a message over the control queue indicating that configuration tables that affect the polling agent have been changed, the polling agent initiates a database synchronization operation to synchronize it configuration information with the master database 300. When the synchronization is complete, the polling agent publishes a message indicating that the synchronization has been completed. In this manner, one or more polling agents may be deployed in a distributed manner and may retrieve configuration information when necessary from the master database.

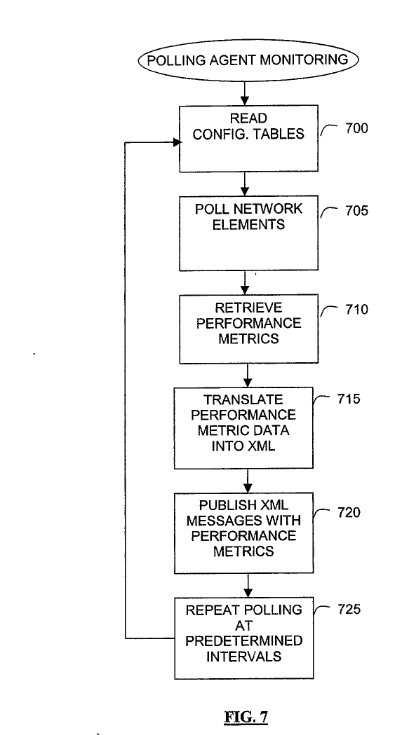

FIG. 7 depicts a method of monitoring a network 227 of network elements using polling agents according to an embodiment of the present invention. Referring to FIG. 7, the polling agent reads a configuration table to determine the network elements, interfaces and services that it is responsible for polling. In step 705, the polling agent performs the polling based on the configuration table. Referring to FIG. 2, it is apparent that polling of different kinds of network may occur according to any convenient protocol. For example, polling may be performed on wireless network elements 235 and/or monitors of wireless network elements 230; on optical network elements 245 and/or on their monitors; ATM/IP network elements 255 or their monitors; or databases 260 and/or their monitors 265. It should be apparent that any type of network may be monitored.

In general the monitors 230-260 and the network elements 235 to 265 store performance information that is capable of being monitored. SNMP specifies a well known protocol for agents (network elements) and their managers which allow for performance polling to occur. The protocols include address information for the agents, performance metric identifiers, and “get” data retrieval protocols that facilitate the reading of the performance information from the agents upon request. The polling agents 220 of the monitoring system according to the present invention include address information for the SNMP agents or their monitors.

The address information is used, together with knowledge of the protocol required to get performance metrics from the monitored network elements and interfaces in step 710. In the case of services, the polling agents may execute a script that entails pinging a service, such as website multiple times to determine availability and average latency. If a response to the ping exceeds a predetermined threshold, the services are classified as unavailable. When multiple pings are made, availability may be determined as a percentage of the pings when the service was found to be available.

The agents may also send trap messages to the polling agents or their monitors. The traps represent alarm conditions and are generally sent over predetermined ports which facilitate their detection at the polling agents and the monitors. The polling agents may, once they receive a trap may publish an alarm message over the alarm message queue.

In step 715, the performance metrics are translated according to a schema prior to transmission over the performance message queue. The translation may be made according to any convenient schema. According to one embodiment of the present invention, the translation is made into an XML format. Subsequently in step 720, the polling agent publishes the performance metrics as XML messages over the performance queue. The performance messages are read by the performance monitor and the archive 205 which stores the performance metric data in an archival format as previously described. The polling agent may publish other useful information with the performance metrics including the start and stop time of the polling cycle and other convenient information. In step 725, the polling is repeated at predetermined intervals according to configuration information stored in the database 300.

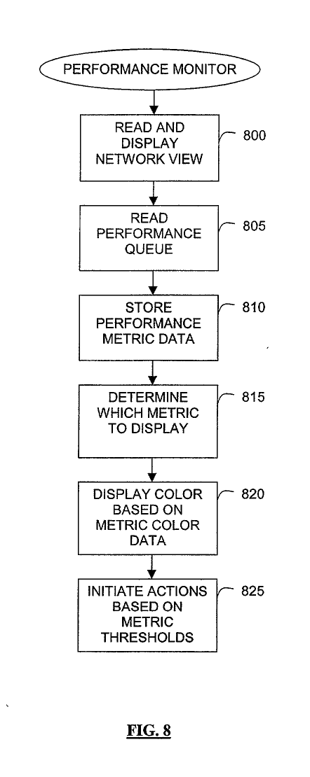

FIG. 8 depicts a method of monitoring the performance of the network according to an embodiment of the present invention. Referring to FIG. 8, in step 800, the performance monitor reads and displays the network view chosen by the user. In step 805, the performance monitor reads the performance queue and in step 810 stores in a buffer performance metric information for the network. In step 815, the performance monitor determines which metric to display based on input from the user or other criteria. The user input may be provided through a menuing structure which displays available metrics for the user to choose. Alternatively, the polling monitor may cycle through the performance metrics one at a time or may be set to a default value for a particular network view.

In step 820, the performance monitor displays a color as part of an icon associated with a hierarchical object depicted in the network view. The hierarchical object may be a network element, link or a subnet or network or network elements. When the object is a network element or link, the color may be selected based on the selected performance metric for that network element. When the object is a subnet or hierarchical depiction of multiple network elements or interfaces, the color may be chosen to represent the worst case element or interface within the object. Any other convenient coloring scheme is contemplated, however, for hierarchical objects including averaging the performance metric data for network elements or interfaces within the object or depicting the best performing element or interface. Combinations of different performance metrics are also contemplated to determine the coloring.

In step 825, the performance monitor may initiate actions or events when any performance metric exceeds a predetermined threshold.

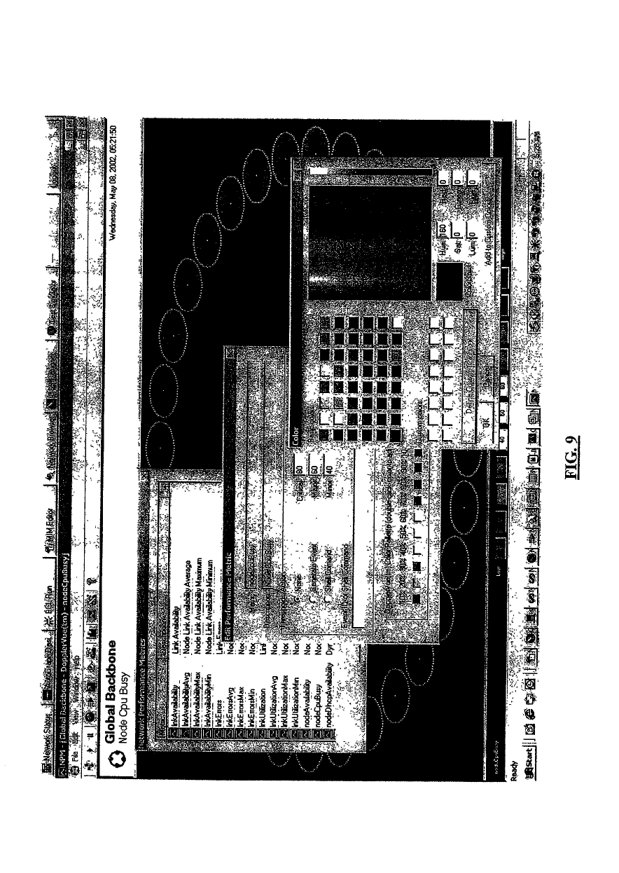

FIG. 9 depicts an illustrative example showing a screen for displaying performance metrics for a network view according to an embodiment of the present invention.

It will be understood that all of the elements of the performance monitoring system may be comprised of software that runs on a general purpose computer or hardware. In the case of software implementations, it will be understood that the software includes program instructions and program logic that may be stored in any computer usable medium that may be stored into memory and executed by a processor of the computer. The program instructions may be executed to perform the steps illustrated and described with respect to all of the methods described herein.

While specific embodiments of the present invention have been described, it will be understood that changes may be made to those embodiments without departing from the spirit and scope of the present invention.

What is claimed is:

1. A method of presenting performance metrics for a network, comprising:
monitoring a plurality of network elements;
publishing performance metrics for the monitored elements;
assigning a color to different performance levels of the elements; and
displaying a hierarchical view of at least some of the monitored elements, wherein the monitored elements are depicted with an assigned color.

2. The method according to claim 1, wherein the view is a map of the network elements.

3. The method according to claim 1, wherein the publishing is performed by transmitting data over message buses.

4. The method according to claim 1, wherein the monitoring includes monitoring data associated with the network elements and the performance metrics are calculated in real time based on the monitored data.

5. The method according to claim 1, wherein at least one monitored element includes configuration data that describes functional parts of the network element.

6. The method according to claim 5, wherein the configuration data defines functional parts of the corresponding network element.

7. A system for presenting performance metrics for a network, comprising:
at least one polling agent, coupled to a plurality of network elements, the polling agent monitoring the a plurality of network elements and publishing performance metrics for the monitored elements;
a database having stored metric information assigning a color to different performance levels of the elements; and
a performance monitor coupled to the database and configured to receive the published performance metrics, the performance monitor displaying a hierarchical view of at least some of the monitored elements, wherein the monitored elements are depicted with the assigned color.

8. The system according to claim 1, further comprising:
a controller publishing a control message over a control queue indicating configuration changes for the at least one polling agent;
wherein the database includes up to date configuration and the polling agent updates its configuration information in response to the control message.

9. The system according to claim 7, wherein the view is a map of the network elements.

10. The system according to claim 7, wherein the publishing is performed by transmitting data over message buses.

11. The system according to claim 7, wherein the monitoring includes monitoring data associated with the network elements and the performance metrics are calculated in real time based on the monitored data.

12. The system according to claim 1, wherein at least one monitored element includes configuration data that describes functional parts of the network element.

13. The system according to claim 12, wherein the configuration data defines functional parts of the corresponding network element.

14. The system according to claim 7, wherein the hierarchical view includes objects that comprise more than one network element and the color for the object is selected based on the worst level of the performance for the metric among the network elements that comprise the object.
